(19) United States
(12) Patent Application Publication
(10) Pub. No.: US 2013/0084433 A1
(43) Pub. Date: Apr. 4, 2013

(54) PREFABRICATED COLUMN WRAP AND METHODS

(71) Applicant: Randall Rob Ernst, Rancho Mirage, CA (US)

(72) Inventor: Randall Rob Ernst, Rancho Mirage, CA (US)

(73) Assignee: Pro-Tech Mats Industries, Inc.

(21) Appl. No.: 13/252,168

(22) Filed: Oct. 3, 2011

(51) Int. Cl. B32B 3/02; B23P 11/00; B29C 43/02

(52) U.S. Cl. 428/174; 264/166; 29/428

(57) ABSTRACT

A prefabricated column wrap assembly for wrapping around a column having a external surface with a predefined shape comprises a polymer form comprising (i) a internal surface having an internal shape that matches the predefined shape of the external surface of the column, and (ii) two opposing laminar edges. A fastening assembly can be provided for fastening the two opposing laminar edges of the polymer form around the column.

### BACKGROUND

Embodiments of the present invention relate to a column wrap and methods of fabricating and assembling column wraps.

Buildings, sheds, and other structures have columns to support the roof joists, ceiling, shelves or other structures. The support columns are typically positioned at periodic intervals and spaced apart from one another. The columns are columnar structures that include for example, poles such as steel, aluminum or wooden poles; reinforced concrete pillars; hollow steel poles filled with cement; and still others. For example, hollow steel poles are often used in shopping centers and discount shopping warehouses. As another example, cement-filled circular steel poles are used in basements of residential houses to support overhead beams and girders. Reinforced concrete pillars are often exposed in the lobbies of multi-storey office and residential buildings.

The columns can be damaged when people or objects bump or collide into the columns, leaving behind dents, scrapes, or even chips. In warehouse-type shopping structures, such as the Wal-Mart™, K-Mart™ and Costco™ warehouses, shoppers with heavy steel shopping carts bumping into the columns cause dents and chips in the columns. Further, the sharp edges and corners of the chipped columns can scrape or otherwise injury shoppers, and such dents and scrapes are also aesthetically undesirable.

In yet another example, hollow steel columns are often used to support roof joists, walkways and other such structures in industrial warehouses. In these environments, heavy forklifts and trucks often maneuver through the building structures. An impact or collision of a heavy fork lift or truck with a steel column can compromise the structural integrity of the column. Failure of even a single column can cause a cascading collapse of a portion of the building structure causing injury or even death of the workers.

Various types of protective coatings have been used to protect the columns of such building structures. For example, polymer-based coatings have been sprayed in-situ, directly onto the columns, to provide a resilient coating that can absorb the shocks of bumps or impacts from shopping carts and other objects. However, the polymer-based coatings often contain solvents or other chemicals which are harmful take a while to dry and can cause smells in the building structure or even be harmful when inhaled. It is also difficult to apply the polymer-based coatings in-situ in buildings without creating a safety inhalation hazard to its occupants. Further, the spraying process can be messy and result in over-spray on adjacent surfaces or floors.

For reasons including these and other deficiencies, and despite the development of various types of protective coatings for columns, further improvements in the fabrication and installation of protective wraps and coverings for columns are continuously being sought.

### SUMMARY

A prefabricated column wrap for wrapping around a column having an external surface with a predefined shape, the prefabricated column wrap comprising a polymer form comprising (i) an internal surface having an internal shape that matches the predefined shape of the external surface of the column, and (ii) two opposing laminar edges.

In another aspect, a fastening assembly can be provided for fastening the two opposing laminar edges of the polymer form around the column.

In still another aspect, a method of forming a prefabricated column wrap for wrapping around a column having a external surface with a predefined shape, comprises forming a mold having a molding surface corresponding to the predefined shape of the external surface of the column, applying debonding film to the molding surface, applying a liquid polymer over the debonding film to form a polymer layer, allowing the polymer layer to set, and peeling off the set polymer layer from the mold to obtain the prefabricated column wrap comprising a polymer form having (i) an internal surface with an internal shape that matches the external shape of the external surface of the column, and (ii) two opposing laminar edges.

In still another aspect, a method of assembling a prefabricated column wrap comprises wrapping a polymer form over the external surface of the column so that the internal surface of the column wrap wraps around the external surface of the column, and fastening the two opposing laminar edges of the polymer form around the column.

In yet another aspect, a prefabricated wrapped column comprises a column having an external surface with a predefined shape, and a prefabricated column wrap comprising a polymer form covering at least a portion of the column, the polymer form comprising a internal surface having an internal shape that matches the predefined shape of the external surface of the column, and having two opposing laminar edges. A fastening assembly for fastening the two opposing laminar edges of the polymer form around the column.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1A is a perspective view of an exemplary embodiment of a prefabricated column wrap having a cylindrical shape that is mounted on a cylindrical column;

FIG. 1B is a perspective view of the prefabricated column wrap of FIG. 1A;

FIG. 1C is a perspective view of a fastening assembly comprising a bar and fasteners;

FIG. 2A is a perspective view of an exemplary embodiment of a prefabricated column wrap having a rectangular shaped mounted on a rectangular column;

FIG. 2B is a perspective view of the prefabricated column wrap of FIG. 2A;

FIG. 2C is a perspective sectional view of the detailed section marked 2C in FIG. 2A, showing a fastening assembly comprising a longitudinal clip with H-shaped cross section that forms a pair of channels;

FIG. 3 is a flowchart of a process for forming a mold for a column wrap;

FIG. 4 is a flowchart of a process for forming a column wrap from a mold;

FIG. 5A is a schematic perspective view of a mold being formed on a preform comprising a cylindrical pole mounted on a jig;

FIG. 5B is a schematic perspective view of the mold for a cylindrical column wrap formed according to FIG. 5A, after it has been stretched out, showing fabrication of a column wrap on the exposed molding surface;

FIG. 5C is a schematic perspective view of the mold for a rectangular column wrap, after it has been stretched out, showing fabrication of a rectangular column wrap on the exposed molding surface;

FIG. 6A is a schematic perspective view of a mold being formed on a preform comprising a cylindrical pole with a textured sheet having texture features with a diamond-like shape wrapped around the pole;

FIG. 6B is a schematic perspective view of a mold having a textured surface which has diamond shaped indents corresponding to the shape of the diamond-like features, formed in FIG. 6A, after it has been stretched out, and showing fabrication of a column wrap on the exposed textured surface of the mold;

FIG. 6C is a perspective view of the column wrap product having a textured surface with textured features having diamond-the shapes formed in the process of FIGS. 6A and 6B;

FIGS. 7A is a perspective schematic view of a rectangular column wrap being stretched out and wrapped around a rectangular column after it has been removed from the stretched-out preform mold shown in FIG. 5C;

FIG. 7B is a perspective schematic view of the rectangular column wrap of FIG. 7A wrapped around a rectangular column with a gap between the opposing laminar edges of the wrap, and showing an exploded view of the fastening assembly to fasten the column wrap to the column;

FIG. 7C is a perspective schematic view of the rectangular column wrap fastened to the column with the fastening assembly; and

FIG. 8 is a schematic perspective view of another embodiment of a column wrap having an interlocking fastening system.

### DESCRIPTION

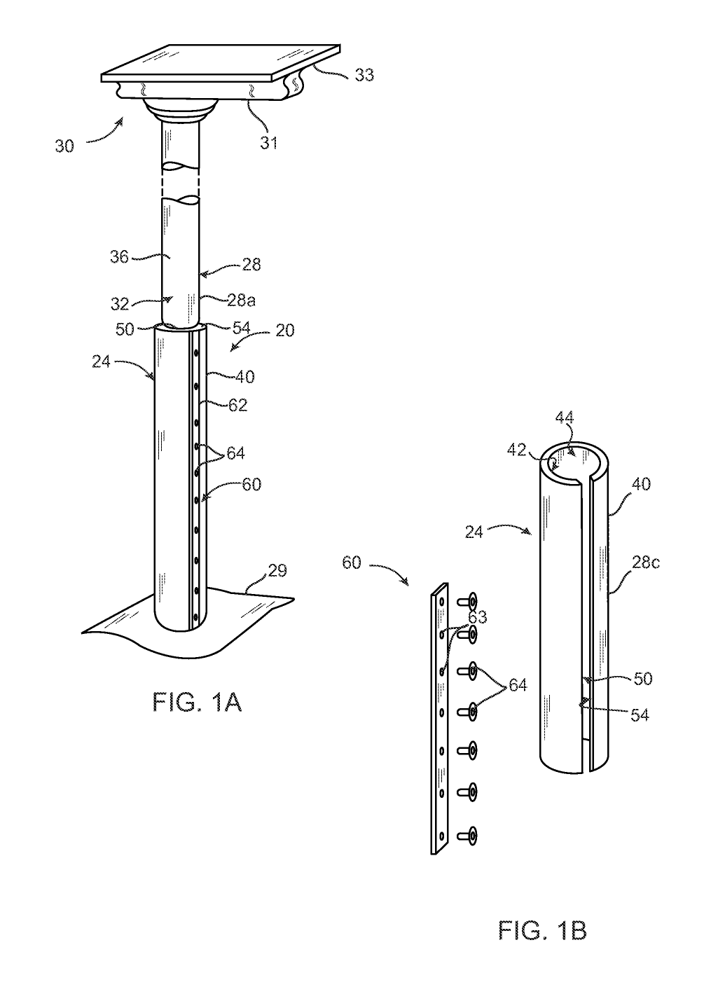

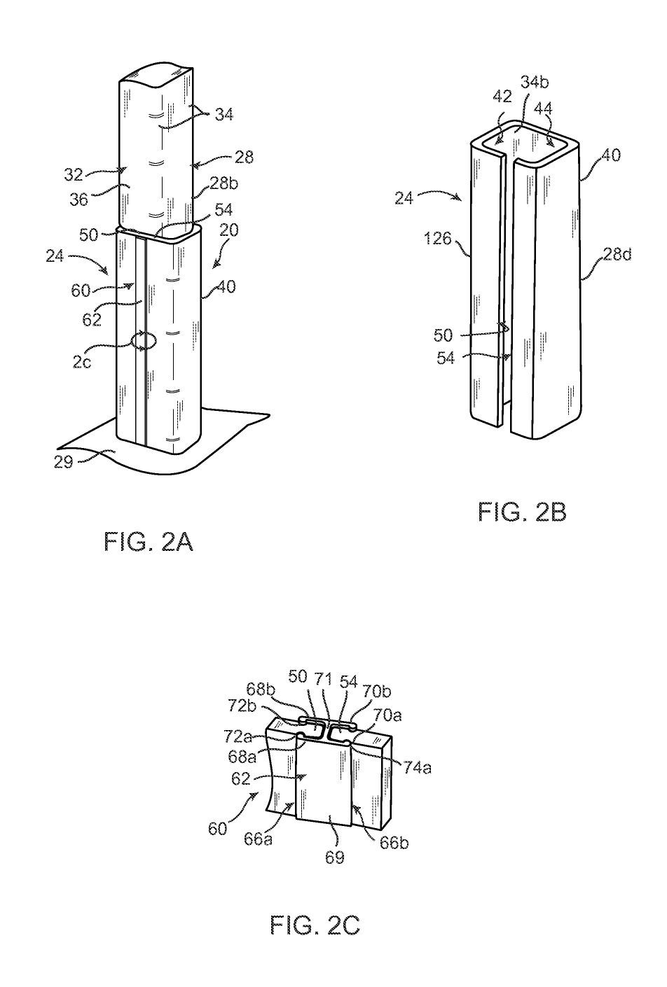

A prefabricated column wrap assembly 20 according to an embodiment of the present invention comprises a prefabricated column wrap 24 that can be wrapped directly onto a column 28 in a building structure 30. An exemplary embodiment of a prefabricated column wrap assembly 20 mounted on a column 28 is illustrated in FIGS. 1A and 2A. The column 28 extends from a floor 29 to a roof joist 31 which supports a ceiling 33 as shown in FIG. 1A. The column 28 has an external surface 30 with a predefined shape 36 onto which the column wrap 24 is fitted. For example, the column 28 can have an external surface 30 with a predefined shape 36 that is a cylinder 28a as shown in FIG. 1A. However, the column 28 could have other predefined shapes 36, for example, rectangular 28b as shown in FIG. 2A such as a rectangle or square; polygonal; hexagonal; or even a complex cross-sectional shape such as a Greek or Roman pillar; and can also have differently shaped bottom support structures, bottom ends, top support structures or capitals. The predefined shape 36 of the external surface 30 of the column 28 can also be thickened with old paint layers, dented, or otherwise distorted from its original shape.

Advantageously, the prefabricated column wrap 24 has an internal surface 42 which is shaped to substantially match the shape of the external surface 30 of the column 28. By substantially matching shape it is meant that the internal surface 42 of the column wrap 24 has a contour or profile that substantially matches the contour or profile of the external shape 36 of the column 28 with a difference in dimension of less than 10% or even less than 5%. For example, when the column 28 has an external surface 32 with an external shape 36 that is a cylinder 28a as shown in FIG. 1A, the column wrap 24 has an internal surface 42 with a corresponding internal shape 44 that is a cylinder 28c as shown in FIG. 1B. As another example, when the column 28 comprises an external surface 30 with an external shape 36 that is rectangular 28b and with chamfered corners 34a, as shown in FIG. 2A, the column wrap 24 has an internal surface 42 with a corresponding internal shape 44 that is also a rectangle 28d with chamfered corners 34b as shown in FIG. 2B. Accordingly, the shaped column wrap 24 can be wrapped around the column 28 to closely fit the shape 36 of the external surface 30 of a column 28, even if the column has an unusual shape or imperfections.

The prefabricated column wrap 24 comprises a free-standing, shaped, polymer form 40 having an internal surface 42 having an internal shape 44 that matches the predefined shape 36 of the external surface 30 of the column 28. The polymer form 40 is a lightweight one-piece structure that conforms to and fits a column 28. For example, the polymer form 40 can have an internal shape 44 with a cross-sectional profile that matches, and mates with, and external cross-sectional profile of the predefined shape 36 of the column 28. The freestanding structure of the prefabricated polymer form 40 facilitates assembly of the form around a column 28 in a building structure 30 without necessitating spraying of hazardous or toxic materials in the building structure 30. As such, the polymer form 40 allows fabrication outside the building structure 30 and thereafter, installation on a column 28 in the building structure 30 with a minimum of disruption of the activities conducted in the building structure 30.

Still further, the prefabricated column wrap 24 can also have a logo 46 stamped or pressed thereon. For example, the logo 46 can be embossed lettering (as shown) of the name of the company or facility using the column wrap 24. In this version, the logo 46 comprises raised lettering that is fabricated directly in the soft polymer form 40. The logo 46 can also be a stenciled design, transfer, inked, or painted design corresponding to a similar trademark of the company using the column wrap 24. Conventional image transferring methods, such as using stickers or stencils can also be used to form the logo 46. In one version, the logo is formed by placing a stencil on the column wrap 24 at the desired position and painting over the cut-out of the stencil with colored liquid comprising polyurea, polyurethane, acrylic, or mixtures thereof to form an image of the cut-out design of the stencil on the column wrap.

The polymer used to fabricate the polymer form 40 has to be resilient to withstand impacts and bumps while also have a sufficiently high flexibility to be wrapped around a three-dimensional shape without deformation or tearing. In one version, the polymer form 40 is a single monolithic structure that is sufficiently strong and flexible to be wrapped around a column 28 without cutting the free-standing form structure into separate component pieces. In one version, the polymer form 40 has a tensile strength of at least about 10 MPa (1450 psi), or even from about 17 MPa (2500 psi) to about 24 MPa (3500 psi), for example about 22 MPa (3200 psi). The polymer form 40 can also have a tear strength of at least about 35,000 N/m (200 pli—pounds of force per linear inch), or even from about 44,000 N/m (250 pli) to about 70,000 N/m (400 pli), or even 57,000 N/m (325 pli). The tear strength is the force required to tear a specified test specimen divided by the specimen thickness. Still further, the polymer form 40 can have a direct impact strength of at least about 900 N/cm (500 lbs/in) or even at least about 1250 N/cm (700 lbs/in). The impact resistance of the polymer form 40 should be sufficiently high at low temperatures, or even subzero temperatures, to prevent brittle fracture or cracking of the polymer at these low temperatures when impacted. The polymer form 40 should also be sufficiently fire resistant to be a class 1 fire rated material as measured under the ASTM designated test E84, entitled “Standard Method of Test for Surface Burning Characteristics of Building Materials.”

In one version, the polymer form 40 is composed at least partially, or substantially entirely, of a polymer, such as for example, polyurea, polyurethane, or mixtures thereof. For example, the polymer form 40 can be composed partially or entirely of polyurea. Generally, urea or carbamide has the chemical formula (NH₂)₂CO in which two amine groups (—NH₂) are joined by a carbonyl functional group (C=O). Polyurea is an elastomer comprising alternating monomer units of isocyanate and amine which have reacted with each other to form urea linkages. Polyurea is derived from the reaction product of (i) an isocyanate, and (ii) a synthetic resin blend component through step-growth polymerization. The isocyanate can be aromatic or aliphatic in nature, a monomer or polymer, or any variant reaction of isocyanates, quasi-prepolymer or a prepolymer. The prepolymer or quasi-prepolymer can be made of an amine-terminated polymer resin, or a hydroxyl-terminated polymer resin. The resin blend may be made up of amine-terminated polymer resins, and/or amine-terminated chain extenders. The resin blend may also contain additives such as hydroxyls, for example, pre-dispersed pigments in a polyol carrier. Urea can also be formed from the reaction of isocyanates and water to form a carbamic acid intermediate which decomposes releasing carbon dioxide and leaving behind an amine, which then reacts with another isocyanate group to form the polyurea linkage.

The polymer form 40 can also be composed partially or entirely of polyurethane, which is a polymer composed of organic units joined by urethane or carbamate groups. Polyurethane can be formed through step-growth polymerization, by reacting an isocyanate monomer with another monomer having at least two hydroxyl or alcohol groups (—OH), in the presence of a catalyst. In one example, the polymer form 40 is made from a polyisocyanate which is a molecule with two or more isocyanate functional groups, R-(N=C=O)_{n≧2}, for example, a diisocyanate polymer having two isocynate groups. Diisocyanate polymers are manufactured for reactions with polyols in the production of polyurethanes. The isocyanate group reacts with the hydroxyl functional group to form a urethane linkage. If a diisocyanate is reacted with a compound containing two or more hydroxyl groups (polyol) or alchohol groups, the resultant long chain polymer is polyurethane. A suitable polyurethane polymer can be made from liquid diisocyanates and liquid polyether or polyester diols. For example, a polyisocyanate having the formula R-(N=C=O)_{n≧2 is} is reacted with a polyol having the formula R′-(OH)_{n≧2} to produce a polyurethane reaction product that is a polymer containing the urethane linkage, —RNHCOOR′-. In one example, the polyurethane comprises DiphenylmethaneDiisocyanate (MDI).

In one example, the polyurethane comprises an isocyanate polymer having the formula R-(N=C=O), where R is a carbon-hydrogen molecule, and the isocyanate group is —N=C=O. Molecules that contain two isocyanate groups are called diisocyanates. These molecules are also referred to as monomers or monomer units, since they themselves are used to produce polymeric isocyanates that contain three or more isocyanate functional groups. Isocyanates can be classed as aromatic, such as diphenylmethane diisocyanate (MDI) or toluene diisocyanate (TDI); or aliphatic, such as hexamethylene diisocyanate (HDI) or isophorone diisocyanate (IPDI). An example of a polymeric isocyanate is polymeric diphenylmethane diisocyanate, which is a blend of molecules with two-, three-, and four- or more isocyanate groups, with an average functionality of 2.7. Isocyanates can be further modified by partially reacting them with a polyol to form a prepolymer. A quasi-prepolymer is formed when the stoichiometric ratio of isocyanate to hydroxyl groups is greater than 2:1. A true prepolymer is formed when the stoichiometric ratio is equal to 2:1.

The polyurethane also includes a polyol (—OH)_{n≧2}. Molecules that contain two hydroxyl groups are called diols, those with three hydroxyl groups are called triols, etc. In practice, polyols are distinguished from short chain or low-molecular weight glycol chain extenders and cross linkers such as ethylene glycol (EG), 1,4-butanediol (BDO), diethylene glycol (DEG), glycerine, and trimethylolpropane (TMP). Polyols are polymers in their own right. They are formed by base-catalyzed addition of propylene oxide (PO), ethylene oxide (EO) onto a hydroxyl or amine containing initiator, or by polyesterification of a di-acid, such as adipic acid, with glycols, such as ethylene glycol, polyethylene glycol, or dipropylene glycol (DPG). Polyols extended with PO or EO are polyether polyols. Polyols formed by polyesterification are polyester polyols. The choice of initiator, extender, and molecular weight of the polyol greatly affect its physical state, and the physical properties of the polyurethane polymer. Important characteristics of polyols are their molecular backbone, initiator, molecular weight, % primary hydroxyl groups, functionality, and viscosity.

The polyurethane also includes a catalyst such as a tertiary amine, such as for example, dimethylcyclohexylamine, and organometallic compounds, for example dibutyltin dilaurate or bismuth octanoate. Suitable catalysts can also be chosen based on whether they favor the urethane (gel) reaction, such as 1,4 diazabicyclo[2.2.2]octane (also called DABCO or TEDA), or the urea (blow) reaction, such as bis-(2- dimethylaminoethyl)ether, or specifically drive the isocyanate trimerization reaction, such as potassium octoate.

In one version, the polymer form 40 is fabricated to have a shaped internal surface 42 and opposing, first and second laminar edges 50, 54, respectively, as for example shown in FIGS. 1B, 2B, 6C and 8. Advantageously, the single pair of opposing laminar edges 50, 54 facilitates assembly of the polymer form 40 around a column 28 as only a single laminar edge needs to be joined to itself or attached to the column 28. The first and second laminar edges 50, 54 extend longitudinally along substantially the entire length of the polymer form 40. In use, the opposing laminar edges 50, 54 are positioned to abut or overlap one another to form an interface for joining the two edges 50, 54 to one another. The opposing laminar edges 50, 54 can have straight edges or interlocking shapes as described below.

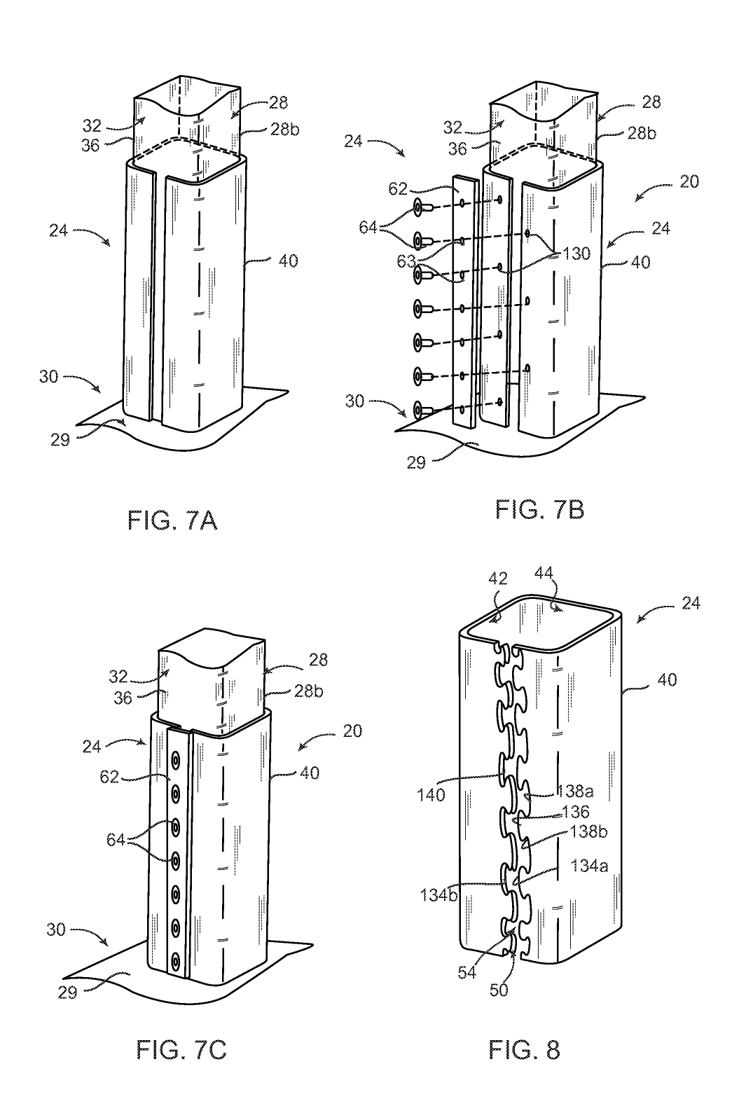

In one version, the column wrap 24 comprises a fastening assembly 60 for fastening the two opposing laminar edges 50, 54 of the polymer form 40 around the column 28. An exemplary fastening assembly 60 comprises a bar 62 having holes 63 therethrough which are attached to the underlying polymer form 40 or the column 28 with a set of fasteners 64, as shown in FIG. 10. The bar 62 can be made from metal, plastic, wood, or even a composite material, such as fiber reinforced plastic or carbon epoxy composites. A suitable bar 62 can be made from extruded anodized aluminum, steel or MDF. Typically, the bar 62 has a length to match that of the column wrap 24, which can be from about 4 feet to about 10 feet. The bar 62 also has a width of from about 0.5 to about 3 inch, and a thickness of from about 1/16 inch to about ¼ inch. In one version, the holes 130 are sized to have a diameter of from about 1/16 inch to about ¼ inch, for example about 3/16 inch. The fasteners 64 are sized to extend through the bar 62, and can have a length of from about ½ inch to about 1½ inch, for example, about ¾ inch; and a diameter the same as the diameter of the drilled holes. The fasteners 64 can be rivets, screws, nails, nuts or other fastening structures. During assembly, the bar 62 is placed over the abutting or overlapping portion of the opposing laminar edges 50, 54 of the polymer form 40, and the fasteners 64 are passed through the holes 130 in the bar 62, through the laminar edges 50, 54, and into the body of the column 28, as for example illustrated in FIGS. 1A, and 7A to 7B, to securely hold the polymer form 40 to the column 28.

In another version, the fastening assembly 60 comprises a bar 62 which is adapted to be snap fitted to the two opposing laminar edges 50, 54, as for example, shown in FIG. 2A and 2C. In this version, the bar 62 comprises a longitudinal clip 69 having an H-shaped cross-section that is defined by a first channel 66a having opposing first legs 68a,b and a second channel 66b having opposing second legs 70a,b. The opposing first legs 68a,b and second legs 70a,b run parallel to one another and extend a short distance away from a central bar 71. The first legs 68a,b comprise first longitudinal bumps 72a,b that extend along the lengths of first legs 68a,b. Similarly, the opposing second legs 78a,b also comprise second longitudinal bumps 74a,b that extend along their lengths. The longitudinal clip 69 having the pair of first and channels 66a,b holds together the first and second laminar edges 50, 54 of the polymer form 40 because the first and second longitudinal bumps 70a,b and 74a,b press against and deform the edges 50, 54 of the polymer form 40 to securely hold them together.

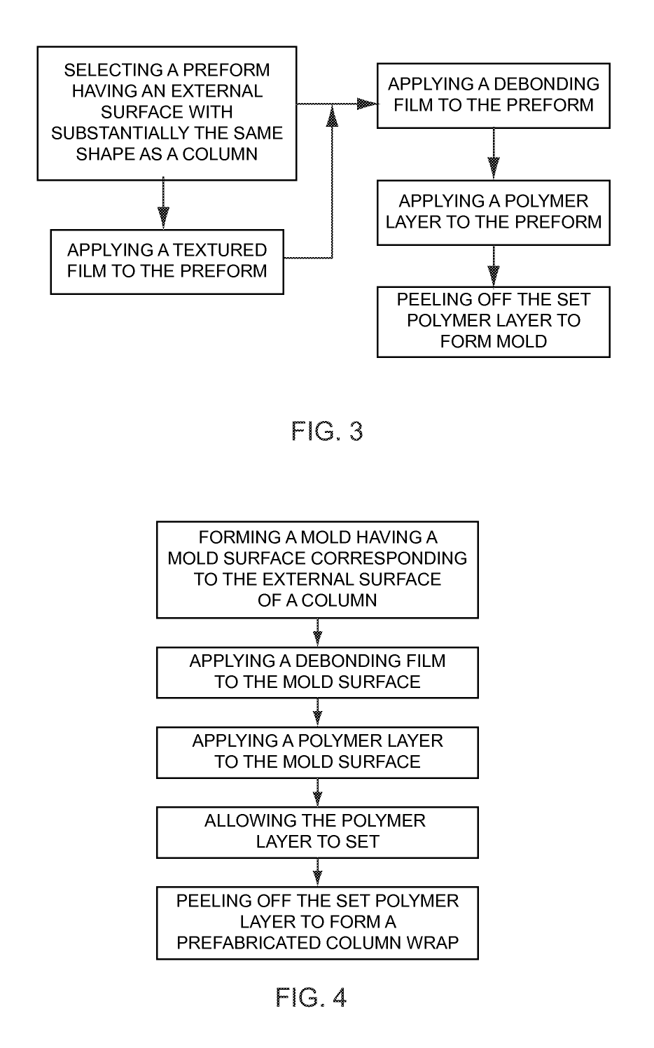

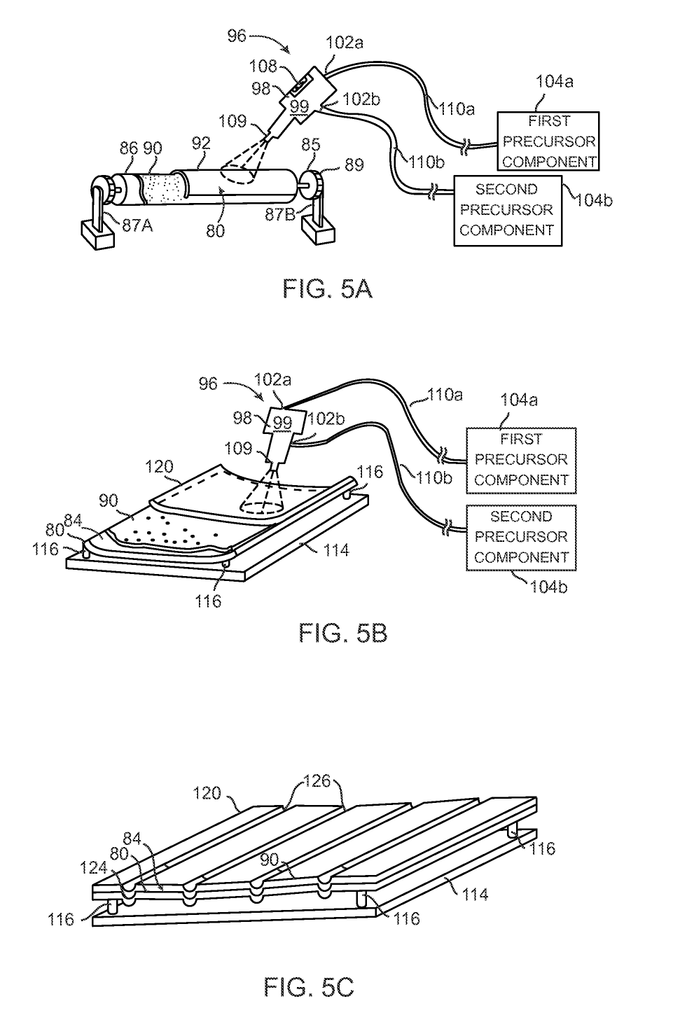

An exemplary embodiment of a process for forming a prefabricated column wrap 24 will be illustrated with reference to the flowcharts of FIGS. 3 and 4. Initially, a mold 80 having a molding surface 84 corresponding to the predefined shape 36 of the external surface 32 of the column 28 is formed using a preform 86, as described in the flowchart of FIG. 3. The preform 86 can be selected to be a portion of the column 28 itself or a cast shape that replicates the predefined shape 36 of the column 28. For example, when the column 28 comprises a hollow steel pole that is used as a column in a steel-trussed warehouse structure, the preform 86 can be a portion of the steel pole itself, as shown in FIG. 5A. Instead of a steel pole, the preform 86 can also be a replica of the steel pole, created in molded plastic, wood, or plaster.

The selected preform 86 is checked so that it does not have any burrs on the edges and holes and cleaned with a cleaning agent, such as an organic solvent, for example, alcohol. Thereafter the preform 86 is loaded onto a rotating axle 85 of a jig 88 which allows rotation of the preform 86 to achieve a uniform thickness of layers applied over the surface of the preform 86. The jig 88 can be a conventional rotation apparatus having a rotating axle 85 mounted on ball bearings supported by posts 87a,b. One or more hand wheels 89 can be used to rotate the axle 85, and thereby, rotate the preform 86.

The molding surface 84 of the preform 86 is coated with a thin debonding film 90 of a debonding agent, as for example, shown in FIG. 5A. The debonding agent can be, for example, a mixture of light hydrocarbons, organic solvent or oil. In one example, the debonding agent is insoluble in water. In a further example, the debonding agent comprises light aliphatic naphtha which comprises a complex mixture of hydrocarbon molecules having between 5 and 12 carbon atoms. Light aliphatic naphtha is the distillate of crude oil comprising the fraction boiling between 30° C. and 90° C. Light aliphatic naphtha comprises hydrocarbon molecules with from about 5 to about 6 carbon atoms. In one version, the debonding agent comprises MR-515-H™, a light aliphatic naphtha fabricated by Chem-Trend Limited Partnership, Howell, Mich. The debonding agent can be applied onto the surface of the preform 86 by spraying, painting or even dipping, to form thin debonding 90 having, for example, a thickness of less than about 1 mm, or even less than 0.5 mm.

Thereafter, the preform 86 is coated with a mold layer 92 which is applied over the debonding film 90 as shown in FIG. 5A, to form a mold 80. The mold layer 92 can be made of any material that can be coated onto the preform by spraying, painting, or dipping, and which easily peels off the preform 86 to retain the shape of its external surface. The debonding film 90 is applied prior to application of the mold layer 92 to prevent sticking of the mold layer 92 to the surface of the preform 86 and to facilitate peeling off of the mold layer 92. The mold layer 92 can be formed, for example, from a polymer, fiberglass, epoxy resin, plaster of paris, clay or silicone. In one example, the mold layer 92 comprises a polymer such as polyurea, polyurethane, or mixtures thereof, and is fabricated with a liquid polymer made by mixing a first precursor component 104a commercially available under the tradename GatorHyde CG, Component A, from Chemline, Inc. St. Louis, Mo., and a second precursor component 104b commercially available under the tradename GatorHyde CG, Component B, also from Chemline. A description of this polymer and a suitable spraying method is provided below.

In one exemplary method, a sprayer 96 is used to spray coat the liquid polymer onto the preform 86 to form the mold layer 92. The ambient application temperature of the room should be from about 40 to about 110° F. The sprayer 96 can be used in a spray booth (not shown) if the polymer vapor should not be inhaled. In one version, the sprayer 96 comprises a spray gun 98 having multiple inlets, such as for example first and second inlets 102a,b, respectively, to separately receive the first precursor component 104a and the second precursor component 104b, respectively. Additional or fewer precursor components can be used depending on the composition of the polymer used in the mold layer 92.

The spray gun 98 is capable of pressurizing, heating and premixing the first and second precursor components 104a,b to a desired temperature. For example, the spray gun 98 can comprise a heater 108 capable of heating the precursor components 104a,b to a temperature of, for example, from about 140 to about 200° F., or even from about 150 to about 170° F., before spraying. The sprayer 96 pressurizes the precursor components 104a,b using hydraulic pressure from a pump (not shown), and pumps the pressurized components through a sprayer nozzle 109 to atomize the same. The sprayer nozzle 109 can be cleared or cleaned by passing compressed air therethrough from an air compressor (not shown) which is turned on prior to spraying from the spray gun 98. The pressurized components are mixed in a mixing chamber 99 in the spray gun 98, and then sprayed at a pressure of at least about 1500 psi, or even from about 2000 to about 3000 psi, or even from about 2000 to about 2500 psi. A suitable sprayer 96 is a two component, high-pressure sprayer, such as a GRACO H-XP2 reaction coating sprayer, and a suitable heated, dual inlet, spray gun 98 is a GRACO FUSION AIR purge spray gun with a sprayer nozzle such as a model 2222 nozzle, all of which are available from Greco Inc., Minneapolis, Minn.

In one version, the mold 80 is formed from a mold layer 92 of polyurea, polyurethane, or mixtures thereof, and is formed by spraying a mixture of first and second precursor components 104a,b through a heated spray gun 98 which heats and mixes the components together as they are sprayed onto the surface of the preform 86. The first and second precursor components 104a,b are separately introduced into the sprayer gun 98 of the sprayer 96 through separate first and second tubes 110a,b. Each tube 110a,b is fed from a tank comprising the first precursor component 104a or second precursor component 104b. The first and second precursor components 104a,b and the tubes 110a,b are maintained at temperatures of from about 150 to about 190° F. The two precursor components 104a,b are mixed together in the heated spray gun 98 prior to being ejected onto the surface of the preform 86 as shown in FIG. 5A.

In one exemplary embodiment, the polymer used for the mold layer 92 comprises polyurea. The polyurea is made by mixing a first precursor component 104a with a second precursor component 104b. The first precursor component 104a is a blend comprising polymethylene polyphenyl isocyanate (from about 10 to about 40 weight %), 4, 4′ diphenylmethane diisocyanates (MDI) (from about 10 to about 40 weight %), MDI prepolymer (CAS No. 39420-98-90) comprising partially reacted isocyanate polymer which has been reacted with a polyol to form a prepolymer (from about 20 to about 60 weight %), and tris(B-chloropropyle) phosphate (from about 1 to about 20 weight %). For example, the MDI pre-polymer can be formed, for example, from polyols such as polyethylene adipate (a polyester) and poly(tetramethylene ether) glycol (a polyether). A suitable first precursor component comprises Chemthane 7061A FR, from Chemline Inc, St. Louis, Mo. In the same embodiment, the second precursor component 104b comprises a mixture of amines and other reaction catalyzing additives. For example, the second precursor component can comprise polyoxypropylenediamine (from about 20 to about 60 weight %), polyoxyalkyleneamine (from about 10 to about 30 weight %), aromatic amines (from about 1 to about 30 weight %), decabromodiphenyl oxide (from about 1 to about 10 weight %) and antimony trioxide (from about 0 to about 5 weight %). The premixed polymer is sprayed uniformly onto the preform 86 while the preform 86 is rotated in the jig 88, to achieve a mold layer 92 comprising a polyurea polymer having a thickness of at least about 0.05 in, or even from about 0.1 to about 0.5 in.

In another exemplary embodiment, the polymer used for the mold layer 92 comprises a mixture of polyurethane and polyurea. In this version, the polymer is made from a first precursor component 104a that is a diphenylmethane diisocyanate (MDI) pre-polymer blend. For example, the first precursor component 104a can comprise diphenylmethane diisocyanates (from about 20 about 50 weight %) which contain 4, 4′ diphenylmethane diisocyanates (MDI) (approximately 27 weight %) and MDI isomers which have the same molecular weight but slightly different structures. The first precursor component 104a is commercially available under the tradename GatorHyde CG-75, Component A, from aforementioned Chemline. In the same embodiment, the second precursor component 104b comprises a polyether polyol system containing aromatic diamines. For example, the second precursor component 104b can comprise polypropylene glycol in a concentration of from about 60 to about 90 weight %, and an aromatic diamine such as diethyltoluenediamine (DETDA) in a concentration of less than 20 weight %. The second precursor component 104b is commercially available under the tradename GatorHyde CG-75, Component B, from aforementioned Chemline.

In yet another exemplary embodiment, the polymer used for the mold layer 92 also comprises a mixture of polyurethane and polyurea. In this version, the first precursor component 104a is also a diphenylmethane diisocyanate (MDI) pre-polymer blend. The first precursor component 104a comprises polyurethane prepolymer in a concentration of about 60 weight %, diphenylmethane diisocyanate with mixed isomers in a concentration of about 20 to weight %, and 4, 4′ diphenylmethane diisocyanates (MDI) in a concentration of from about 18 weight %. The first precursor component 104a is commercially available under the tradename GatorHyde CG, Component A, from aforementioned Chemline, Inc. In the same embodiment, the second precursor component 104b comprises a polyether polyol system containing aromatic diamines. For example, the second precursor component 104b can comprise polypropylene glycol in a concentration of from about 60 to about 90 weight %, and an aromatic diamine such as diethyltoluenediamine (DETDA) in a concentration of less than 20 weight %. The second precursor component 104b is commercially available under the tradename GatorHyde CG, Component B, from aforementioned Chemline, Inc.

After the mold layer 92 is formed to the desired thickness by spraying the polymer onto the preform 86, the coated mold layer 92 is allowed to set by allowing the mold layer to cool in the atmosphere for at least about 20 seconds, or even for at least about 30 seconds. The setting process can result from evaporation of solvent from the polymer, condensation and/or polymerization of the polymer of the mold layer 92, resulting in formation of a flexible and coherent layer structure on the preform 86. The set mold layer 92 is peeled off the preform 86 to form a mold 80 which can be used to form the column wrap 24.

A column wrap 24 comprising a polymer form 40 is now fabricated on the exposed molding surface 34 of the mold 80, as described in the exemplary process embodiment of FIG. 4. The peeled-off mold 80 is sufficiently flexible when made from a polymer that it can be stretched-out to provide an exposed molding surface 84 having an imprint of, and corresponding to, the external surface 30 of the column 28 which is the same as the exposed surface of the preform 86. The stretched-out mold 80 as a molding surface 34 is attached to a platform 114 using a plurality of pins 116, for example, at the four corners of the mold 80 as shown in FIG. 5B. After the mold 80 has been stretched-out on the platform 114, another debonding film 90 is formed onto the molding surface 84 of the mold 80. The debonding film 90 can be made from the same debonding agent as described above, or other commonly used debonding agents, such as oil, grease, or even Teflon™, DuPont de Nemours Wilmington, Del.

Thereafter, a polymer layer 120 comprising a liquid polymer is formed on the molding surface 84 to fabricate the polymer form 40 of the column wrap 24. The polymer layer 120 conforms to the shape or surface profile of the molding surface 84 to form a polymer form 40 that is conformal to the shape of the mold 80. For example, when the mold 80 is made from a preform 86 comprising a pole, the resultant mold 80 comprises a molding surface 84 that is a gently arcuate surface when stretched-out as schematically shown in FIG. 5B. The resultant polymer form 40 from the arcuate molding surface 84 comprises a cylinder as shown in FIG. 1B. The polymer form 40 comprising the cylinder has an internal surface 42 that is uniformly arcuate to form an internal shape 44 that is the cylinder.

As another example, when the preform 86 comprises a rectangular shape having chamfered corners 34, and resultant mold 86 has a molding surface 84 with dents 124 corresponding to the chamfered corners 34 of the original column 28b that provides a rectangular preform 86 having predefined corner grooves 126, as shown in FIG. 5C. As a result, the polymer form 40 that is rectangular in shape, as shown in FIG. 2B, has predefined corners 126 that are substantially matched in shape and dimensions to the profile of the corners 34 of the rectangular column 28b. This greatly simplifies wrapping and assembly of the rectangular column wrap 24 over a rectangular column 28b, as shown in FIGS. 2A and 7A to 7C.

The polymer form 40 is fabricated from a polymer layer 120 which can be composed of the same polymer as that used to make the mold 80 on the preform 86 or a different polymer. In one exemplary embodiment, the polymer layer 120 also comprises a polyurethane, polyurea, or mixtures thereof, and is fabricated by spraying a liquid polymer made by mixing first and second precursor components 104a,b onto the molding surface 84 as shown in FIG. 5B. As before, the first precursor component 104a is a blend comprising polymethylene polyphenyl isocyanate (from about 10 to about 40 weight %), 4, 4′ diphenylmethane diisocyanates (MDI) (from about 10 to about 40 weight %), MDI prepolymer (from about 20 to about 60 weight %) and tris(B-chloropropyle) phosphate (from about 1 to about 20 weight %). A suitable first precursor component comprises Chemthane 7061A FR, from Chemline Inc, St. Louis, Mo. In the same embodiment, the second precursor component 104b comprises a mixture of amines and other reaction catalyzing additives. For example, the second precursor component can comprise polyoxypropylenediamine (from about 20 to about 60 weight %), polyoxyalkyleneamine (from about 10 to about 30 weight %), aromatic amines (from about 1 to about 30 weight %), decabromodiphenyl oxide (from about 1 to about 10 weight %) and antimony trioxide (from about 0 to about 5 weight %). The premixed polymer is sprayed uniformly onto the molding surface 34 to achieve a polymer layer 120 having a thickness of at least about 0.05 inch, or even from about 0.05 to about 0.5 inch.

A color can be premixed with a component of the liquid polymer so that the cured polymer has a predefined color. For example, commonly used colors can include white, gray, tan, red or black. The applied liquid polymer layer 120 on the molding surface 84 of the mold 80 is allowed to settle for sufficient time which is typically at least about 20 seconds, or even at least about 30 seconds which is the tack-free time.

The cured polymer layer 120 is peeled off from the mold 80 to obtain a polymer form that is the prefabricated column wrap 24 having an internal surface 42 with an internal shape and with two opposing laminar edges 50, 54. In one example, the polymer form 40 has a height of from about 5 to about 10 feet, for example from about 6 to about 8 feet; a width of from about 24 to about 40 inch, or for example from about 32 to about 42 inch. The polymer form 40 can have a thickness of from about 1/32 to about ⅛ inch, for example about 1/16 inch.

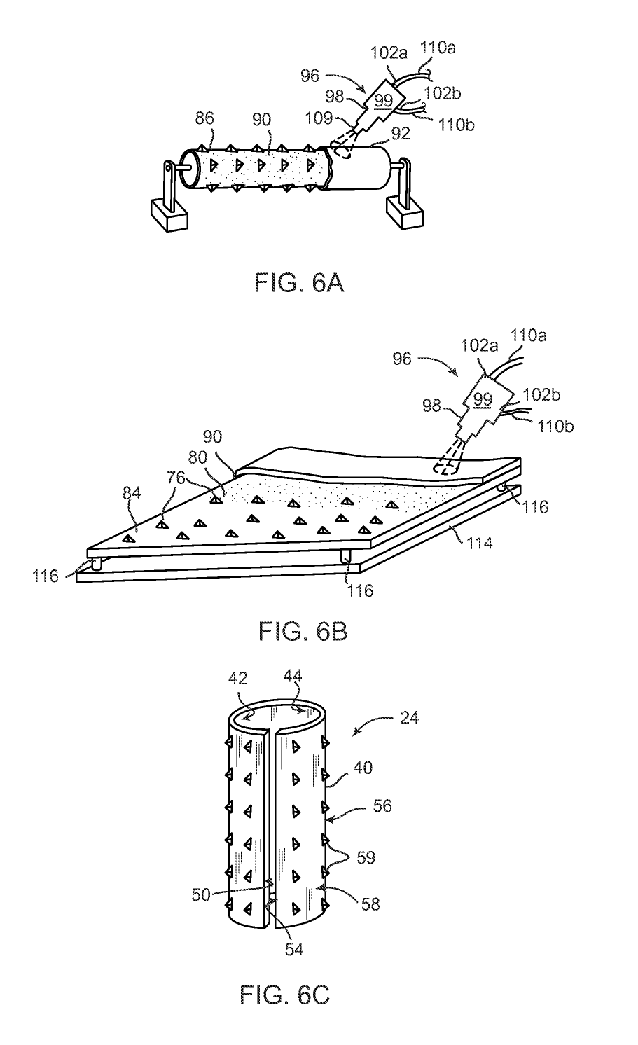

The column wrap 24 can comprise a polymer form 40 having an external surface 56 that is a smooth surface as shown in FIGS. 1B and 2B, or a textured surface 58 as shown in the exemplary embodiment of FIG. 6C. For example, the external surface 56 can be a textured surface 58 having spaced apart texture features 59. In one example, the texture features 59 comprise diamond-like shapes, bumps or recesses, tetrahedrons, polyhedrons, or other shapes. For example, the texture features 59 can be a Levant pattern, or spaced apart diamond-like shapes such as those found on diamond-shape stamped sheet metal parts. In the version shown, the texture features 59 comprise diamond-like shapes having, for example, a height of from about 0.02 inch to about 0.4 inch. Advantageously, the texture features 59 can increase the strength of the polymer form 40 to impacts, tensile stresses or strains, and stresses.

The textured surface 58 of the column wrap 24 can be formed by wrapping a textured sheet 65 onto the surface of a preform 86 as shown in FIG. 6A. The textured sheet 65 has texture features 75 identical in shape to the desired texture features 59 on the polymer form 40 of the column wrap 24. For example, when the texture features 59 comprise spaced apart diamond-like shapes, the texture features 75 of the textured sheet 65 also have the same diamond-like features. As shown, the textured sheet 65 is wrapped around the preform 86 and a debonding film 90 is applied to the surface of the textured sheet 65. Polymer is sprayed onto the surface of the textured sheet 65 to form a mold layer 92 with the textured features imprinted thereon. The mold layer 92 is then unwrapped from the preform 86 and spread apart to form a mold 80 having a molding surface 84 with imprinted recesses 76 corresponding to the shape of the texture features 75 as shown in FIG. 6B. A debonding film 90 is then applied to the surface, and a second polymer layer is sprayed thereon to form a polymer form 40 having a textured surface 58 with the textured features 59 as shown in FIG. 6C.

In the same manner, a logo 46 comprising embossed lettering of the name of the company or facility using the column wrap 24, as shown in FIG. 2B, can be formed by wrapping a textured sheet 65 onto a surface of the preform 86, the textured sheet 65 comprising an indented or raised pattern of text used for forming the logo 46, or a series of logos 46, spaced apart from one another. In this manner, the raised logo pattern of the logo 46 is transferred directly to the surface of the preform 86 to form a mold 80 having a molding surface with the imprinted logo 46 thereon. In the fabrication of a column wrap 24 from such a mold, a debonding film 90 is applied to the molding surface, and thereafter, a second polymer layer is sprayed thereon to form a polymer form 40 having the logo 46 imprinted thereon, as shown in FIG. 2B. The logo 46 can also be a stenciled design, transfer, inked, or painted design that is applied to a finished column wrap 24.

A fastening assembly 60 can also be fabricated to facilitate assembly of the column wrap 24 around a column 28. In one exemplary embodiment, the fastening assembly 60 comprises a bar 62 from a metal or MDF (medium density fiberboard). In one example, the bar 62 comprises a thickness of from about 0.05 inch to about 0.25 inch. The bar 62 is shear or saw cut to a desired length of from about 2 to about 6 feet depending on the length of the polymer form 40, so that the bar covers the entire length of the polymer form. Thereafter, the cut bar 62 is drilled with evenly spaced apart, mounting holes 63 along its edges. The holes 63 can be arranged along a linear length or staggered and offset from one another. After drilling of the holes 63, the bar 62 is wiped clean a solvent, such as acetone on both sides and checked for burrs on the edges and holes, which if found, are filed until smooth. Thereafter both sides of the bar 62 are coated by spraying using the same polymer as that used to fabricate the polymer form 40 to provide a matching look, or with another durable coating polymer or even paint.

In assembly, the prefabricated column 28 is wrapped around the circumference of a column 28 as shown in FIG. 7A. The polymer form 40 can be rotated around the column 28 to provide the best fit to the shape of the external surface 32 or surface profile of a particular column 28. The external surface 32 of the column 28 is wrapped around with the polymer form 40 of the column wrap 24 so that the shaped internal surface 42 of the polymer form 40 snugly fits the shape of the external surface 32 of the column 28. Once wrapped around the column 28, the polymer form 40 is held in place using masking tape at one or more sections of the column 28. Thereafter, the two opposing laminar edges 50, 54 of the polymer form 40 can be maintained spaced apart from one another with a small gap therebetween of from about 0.05 inch to 1 inch, abutted against one another so that the edges 50, 54 contact one another, or overlapped over one another so that a portion of one edge 50 is superimposed over the other edge 54. For example, when a cylindrical polymer form 40 is wrapped around the column 28 such as a steel pole, the laminar edges 50, 54 are overlapped over one another. As another example, when a rectangular polymer form 40 is wrapped around a column 28 which is a rectangular pillar, the laminar edges 50, 54 are spaced apart to form a gap therebetween, the gap being covered by the bar 62.

Thereafter, a prefabricated bar 62 as for example shown in FIG. 10, is placed over the overlapping or gap-spaced laminar edges 50, 54 of the polymer form 40 and used as a template to drill holes 130 through the abutting or overlapping laminar edges 50, 54 of the polymer form 40 and into the column 28, as shown in FIG. 7B. The holes 130 can be placed in a staggered relationship to one another to provide a stronger joint. In one example, the holes 130 are sized to have a diameter of from about 1/16 inch to about ¼ inch, for example about 3/16 inch. The two opposing laminar edges 50, 54 of the prefabricated column wrap 24 are then fastened to one another and to the column 28 by passing fasteners 64 such as pop rivets with a rivet gun into each of the drilled holes 63 in the bar 62 and the holes 130 in the polymer form 40 and column 28 to form the structure shown in FIG. 7C. The bar 62 provides an additional protection at the overlapping interface of the laminar edges 50, 54 of the polymer form 40, and also reduces tearing of the polymer form 40 from the fasteners 64 when tensile stresses are applied at these points.

Referring back to FIG. 2C, an alternate embodiment of a fastening assembly 60 comprises a longitudinal clip which has an H-shaped cross section which defines a pair of channels 66. The longitudinal clip is extruded to form pairs of opposing first legs 68a,b with first longitudinal bumps 72a,b, and second legs 70a,b with second longitudinal bumps 74a,b. In assembly, after the polymer form 40 is wrapped around the column 28, the first laminar edge 50 of the polymer form 40 is pressed into one side of the longitudinal clip, into a first channel 66 so that the opposing first bumps 72a,b of the first legs 68a,b press into and hold the laminar edge 50. Similarly, the second laminar edge 54 of the polymer form 40 is pressed into the other side of the longitudinal clip and into the other channel 66 so that the opposing second bumps 74a,b of the second legs 68a,b press into and hold the laminar edge 54. In this manner, the longitudinal clip with H-shaped cross section is adapted to be snap-fitted to the two opposing laminar edges 50, 54, to hold together the first and second laminar edges 50, 54 of the polymer form 40 without the use of fasteners or other such structures.

In still another embodiment, the polymer form 40 is held together without a fastening assembly 60. In one exemplary embodiment, as shown in FIG. 8, the opposing laminar edges 50, 54 of the polymer form 40 are cut to form interlocking structures 134a,b which interlocking into one another to fasten the edges 50, 54 together. Example, in the version shown, the interlocking structure 134a comprises an oval 136 with cutout base corners 138a,b. The opposing interlocking structure 134b comprises a cutout oval 140 which matches in shape to the oval 136. The opposing pairs of the two interlocking structures 134a,b are pressed into one another to form a fastening system that holds together the polymer form 40 around the column 28. While an exemplary embodiment of the two interlocking structures 134a,b is illustrated, the structures 134a,b can also have other shapes, for example, circular, rectangular, polygonal or still other shapes, as would be apparent to those of ordinary skill in the art.

Advantageously, the column wrap 24 comprising a polymer form 40 having various shapes, can be wrapped around a pre-existing column 28 in a building structure 30 and assembled in situ without ceasing operations in the building structure or having adverse or toxic effects on its occupants. Still further, the column wrap 24 can be molded to have substantially the exact same shape as a particular column 28 providing flexibility for adapting the shape of the column wrap 24 to different styles of columns. Still further, the column wrap 24 protects and prevents denting and abrasion of columns 28 in shopping and industrial applications.

While particular structures and sequences of fabrication and assembly steps are used to illustrate embodiments of the column wrap 24 of the present invention, it should be understood that other structures or sequences of process steps can also be used as would be apparent to one of ordinary skill in the art. For example, the material used to fabricate the polymer form 40 can be substituted with other types of materials, such as for example, composite polymers containing fibers or other materials. Still further, the spraying process steps can be changed to dipping or other coating processes as would be apparent to those of ordinary skill in the art. Therefore, the spirit and scope of the appended claims should not be limited to the description of the preferred versions contained herein.

What is claimed is:

1. A prefabricated column wrap for wrapping around a column having an external surface with a predefined shape, the prefabricated column wrap comprising a polymer form comprising (i) an internal surface having an internal shape that matches the predefined shape of the external surface of the column, and (ii) two opposing laminar edges.

2. A column wrap according to claim 1 wherein the polymer form comprises polyurea, polyurethane, or mixtures thereof.

3. A column wrap according to claim 1 wherein the polymer form comprises a tensile strength of at least about 10 MPa.

4. A column wrap according to claim 1 wherein the polymer form comprises a tear strength of at least about 35,000 N/m.

5. A column wrap according to claim 1 wherein the polymer form comprises direct impact strength of at least about 900 N/cm.

6. A column wrap according to claim 1 further comprising a fastening assembly for fastening the polymer form around the column by fastening the two opposing laminar edges of the polymer form.

7. A prefabricated column wrap assembly for wrapping around a column, the column having an external surface with a predefined shape, and the prefabricated column wrap comprising:
(a) a polymer form comprising (i) an internal surface having an internal shape that matches the predefined shape of the external surface of the column, and (ii) two opposing laminar edges; and
(b) a fastening assembly for fastening the polymer form around the column by fastening the two opposing laminar edges of the polymer form.

8. A column wrap assembly according to claim 7 wherein the polymer form comprises polyurea, polyurethane, or mixtures thereof.

9. A column wrap assembly according to claim 7 wherein the polymer form is composed of a polymer having at least one of the following properties:
(1) a tensile strength of at least about 10 MPa;
(2) a tear strength of at least about 35,000 N/m; and
(3) a direct impact strength of at least about 900 N/cm.

10. A method of forming a prefabricated column wrap for wrapping around a column having a external surface with a predefined shape, the method comprising:
(a) forming a mold having a molding surface corresponding to the predefined shape of the external surface of the column;
(b) applying a debonding film to the molding surface;
(c) applying a liquid polymer over the debonding film to form a polymer layer;
(d) allowing the polymer layer to set; and
(e) peeling off the set polymer layer from the mold to obtain the prefabricated column wrap comprising a polymer form having (i) an internal surface with an internal shape that matches the external shape of the external surface of the column, and (ii) two opposing laminar edges.

11. A method according to claim 10 comprising forming a mold by applying a liquid polymer over the external surface of a preform having substantially the same external shape as the predefined shape of the external surface of the column.

12. A method according to claim 10 comprising applying a liquid polymer comprising polyurea, polyurethane, or mixtures thereof.

13. A method of assembling a prefabricated column wrap formed according to the method of claim 10 around a column, the method comprising:
(1) wrapping the polymer form over the external surface of the column so that the internal surface of the column wrap wraps around the external surface of the column; and
(2) fastening the two opposing laminar edges of the polymer form around the column.

14. A method according to claim 13 wherein (2) comprises fastening the two opposing laminar edges of the polymer form with a fastening assembly.

15. A method according to claim 13 wherein (2) comprises placing a steel bar over the two opposing laminar edges of the polymer form, and riveting the steel bar to the column.

16. A prefabricated wrapped column comprising:
(a) a column having an external surface with a predefined shape; and
(b) a prefabricated column wrap comprising:
(i) a polymer form covering at least a portion of the column, the polymer form comprising a internal surface having an internal shape that matches the predefined shape of the external surface of the column, and having two opposing laminar edges; and
(ii) a fastening assembly for fastening the two opposing laminar edges of the polymer form around the column.

17. A column according to claim 16 wherein the column comprises a hollow steel pole.

18. A column according to claim 16 wherein the polymer form comprises a cylindrical or rectangular shape.

19. A column according to claim 16 wherein the polymer form comprises polyurea, polyurethane, or mixtures thereof.

20. A column according to claim 16 wherein the polymer form is composed of a polymer having at least one of the following properties:
(1) a tensile strength of at least about 10 MPa;
(2) a tear strength of at least about 35,000 N/m; and
(3) a direct impact strength of at least about 900 N/cm.
